(19) United States
(12) Patent Application Publication
(10) Pub. No.: US 2025/0358545 A1
(43) Pub. Date: Nov. 20, 2025

(54) METHOD FOR REDUCING ROUTINGS BETWEEN MODULES, SIGNAL TRANSMISSION METHOD AND APPARATUS, AND IMAGE SENSOR

(71) Applicant: GALAXYCORE SHANGHAI LIMITED CORPORATION, Shanghai (CN)

(72) Inventors: Mengru CHEN, Shanghai (CN); Qianqian JI, Shanghai (CN); Xin ZHOU, Shanghai (CN)

(73) Assignee: GALAXYCORE SHANGHAI LIMITED CORPORATION, Shanghai (CN)

(21) Appl. No.: 18/870,194

(22) PCT Filed: Oct. 9, 2022
(86) PCT No.: PCT/CN2022/123968

§ 371 Date: Nov. 27, 2024

(30) Foreign Application Priority Data
Dec. 13, 2021 (CN) 202111518521.2

(51) Int. Cl. H04N 25/76; H04N 25/766; H04N 25/767; H04N 25/771

(52) U.S. Cl. CPC H04N 25/7795; H04N 25/766; H04N 25/767; H04N 25/771

(57) ABSTRACT

A method for reducing routing between modules, a signal transmission method and apparatus, and an image sensor are provided. The method includes: determining a first signal line and at least one second signal line that are capable of being multiplexed, wherein the first signal line is used to transmit a first signal, and the second signal line is used to transmit a second signal; determining time-division control logic; connecting two terminals of the at least one second signal line to two terminals of the first signal line, respectively, and deleting the at least one second signal line; and controlling to transmit the first signal and the second signal on the first signal line according to the time-division control logic. Embodiments of the present disclosure may effectively reduce a number of routings between modules, thereby reducing a chip size and improving miniaturization of a device.

### CROSS-REFERENCE TO RELATED APPLICATIONS

The present application is a National Stage Application of PCT International Application No.: PCT/CN2022/123968 filed on Oct. 9, 2022, which claims priority to Chinese Patent Application 202111518521.2, filed in the China National Intellectual Property Administration on Dec. 13, 2021, the disclosure of which is incorporated herein by reference in its entirety.

### TECHNICAL FIELD

The present disclosure generally relates to signal transmission technology field, and more particularly, to a method for reducing routings between modules, a signal transmission method and apparatus, and an image sensor.

### BACKGROUND

Image sensors that can convert light signals into electric signals are widely applied in digital television and visual communication markets. Complementary Metal Oxide Semiconductor (CMOS) image sensors are typical solid-state imaging sensors that integrate an image acquisition unit and a signal processing unit on a same chip, and thus are suitable for large-scale mass production and widely used in small and micro cameras for security use, mobile phones, computer network video conferencing systems, wireless handheld video conferencing systems, barcode scanners, fax machines, toys, some automotive camera systems, and etc.

A CMOS image sensor generally consists of a pixel unit array, a row driver, a column driver, timing control logic, an AD converter, a data bus output interface, a control interface, and etc., which are usually integrated on a same chip. In addition, other digital signal processing circuits may be integrated on the CMOS image sensor chip, such as circuits for automatic exposure control, non-uniform compensation, white balance processing, black level control, and gamma correction. To perform fast calculation, programmable DSP devices can even be integrated with CMOS devices to form a single-chip digital camera and image processing system. Accordingly, there may be a large number of signal routings among modules in the CMOS image sensor, especially in the image sensor with non-stacked structures, where there are few metal layers, and distances between modules and between routings are long. The signal routings between modules require a large chip area, making the CMOS sensor having a large size and occupying more space.

### SUMMARY

In one aspect, an embodiment of the present disclosure provides a method for reducing routings between modules, which may effectively reduce a number of routings between modules, thereby reducing a chip size and improving miniaturization of a device.

In another aspect, an embodiment of the present disclosure further provides a signal transmission method and apparatus to improve transmission capability of a signal line.

In another aspect, an embodiment of the present disclosure further provides an image sensor with a decreased size.

Therefore, the embodiments of the present disclosure provide following technical solutions.

An embodiment of the present disclosure provides a method for reducing routings between modules, including: determining a first signal line and at least one second signal line that are capable of being multiplexed, wherein the first signal line is used to transmit a first signal, and the second signal line is used to transmit a second signal; determining time-division control logic; connecting two terminals of the at least one second signal line to two terminals of the first signal line, respectively, and deleting the at least one second signal line; and controlling to transmit the first signal and the second signal on the first signal line according to the time-division control logic.

Optionally, the first signal line is any one of the following: a signal line for transmitting a control waveform, or a signal line for transmitting an operating parameter.

Optionally, the at least one second signal line includes one or more second signal lines; and the at least one second signal line includes any one or more of the following: the signal line for transmitting the control waveform, or the signal line for transmitting the operating parameter.

Optionally, the time-division control logic includes: controlling to transmit the first signal and the second signal on the first signal line in a time-division manner based on a time-division selection signal and a latch signal.

Optionally, the method further includes: in a case where a plurality of latch signals are required, reducing a number of the plurality of latch signals by a manner of encoding.

An embodiment of the present disclosure further provides a signal transmission method, including: multiplexing a second signal onto a first signal line used to transmit a first signal; and controlling to transmit the first signal and the second signal on the first signal line in a time-division manner according to time-division control logic.

Optionally, the first signal and the second signal include any one or more of the following: an operating parameter signal and a control waveform signal.

Optionally, said controlling to transmit the first signal and the second signal on the first signal line in the time-division manner according to the time-division control logic includes: controlling to transmit the first signal and the second signal on the first signal line in the time-division manner based on a time-division selection signal and a latch signal.

Optionally, the method further includes: in a case where a plurality of latch signals are required, generating the plurality of latch signals by a manner of encoding.

An embodiment of the present disclosure further provides a signal transmission apparatus, including: a first signal transmission module, a first signal reception module and at least one second signal transmission module connected to the first signal transmission module via a signal line, and at least one second signal reception module and a control module connected to the at least one second signal transmission module via the signal line; wherein the first signal transmission module is configured to output a first signal; the at least one second signal transmission module is configured to output a second signal; and the control module is configured to control to transmit the first signal to the first signal reception module and transmit the second signal to the at least one second signal reception module on the signal line in a time-division manner according to time-division control logic.

Optionally, the first signal and the second signal include any one or more of the following: an operating parameter signal and a control waveform signal.

Optionally, the second signal and the first signal are signals of a same type or signals of different types.

Optionally, the apparatus further includes a port selection module; wherein the control module is configured to output a time-division selection signal to the first signal transmission module and the at least one second signal transmission module respectively, and output a control signal to the port selection module to control the port selection module to be connected to the first signal reception module and the at least one second signal reception module in a time-division manner.

Optionally, the second signal is an operating parameter signal, and the port selection module includes at least one memory connected to the at least one second signal reception module and used to store the second signal.

Optionally, the at least one second signal transmission module and the at least one second signal reception module include a plurality of second signal transmission modules and a plurality of second signal reception modules; and the apparatus further includes an encoding module configured to encode the control signal and output a latch signal for controlling operation of each of the at least one memory.

An embodiment of the present disclosure further provides an image sensor, including the above signal transmission apparatus.

In the method for reducing routings between modules provided in the embodiments of the present disclosure, signals that need to be transmitted by different signal lines are multiplexed onto one signal line in a time-division multiplexing manner, thereby effectively reducing a number of signal lines. In particular, for a layout design with few metal layers and long distances between modules and between routings, a chip size may be effectively reduced, and miniaturization of a device may be improved.

Accordingly, the signal transmission method and apparatus, and the sensor provided in the embodiments of the present disclosure multiplex different signals onto the same signal line, and control transmission of the different signals on the signal line in a time-division manner according to time-division control logic, which may effectively improve transmission capability of the signal line and reduce a number of signal lines.

### BRIEF DESCRIPTION OF THE DRAWINGS

FIG. 1 is a flow chart of a method for reducing routings between modules according to an embodiment of the present disclosure;

FIG. 2 is a flow chart of a signal transmission method according to an embodiment of the present disclosure; and

FIG. 3 is a structural block diagram of a signal transmission apparatus according to an embodiment of the present disclosure.

### DETAILED DESCRIPTION

In order to make the above-mentioned objects, features and advantages of the present disclosure more obvious and easier to understand, specific embodiments of the present disclosure are described in detail below in conjunction with accompanying drawings.

In existing techniques, a large number of signal routings are required between modules in some chips (such as CMOS image sensors), which occupy a large amount of chip area, making the CMOS sensor large in size. Embodiments of the present disclosure provide a method for reducing routings between modules, and a signal transmission method and apparatus, so as to reduce a number of signal lines and improve transmission capability of the signal lines.

Generally, the signal routings are roughly classified into two types, where one is a waveform signal that varies in real time to provide a control function, and the other is a signal used to transmit stable circuit operating parameters. For signal routings that transmit different types of signals, any one of the two types of signal lines can be used to transmit the other type of signal, that is, two different types of signals are multiplexed onto the same signal line for time-division transmission. Alternatively, two different signals of the same type can also be multiplexed onto any one of the signal lines for time-division transmission to reduce a total amount of transmission signal lines. It should be noted that a multiplexing method may be two or more signals for multiplexing transmission, which can be considered comprehensively according to needs and complexity of multiplexing logic, and is not limited in the embodiments of the present disclosure.

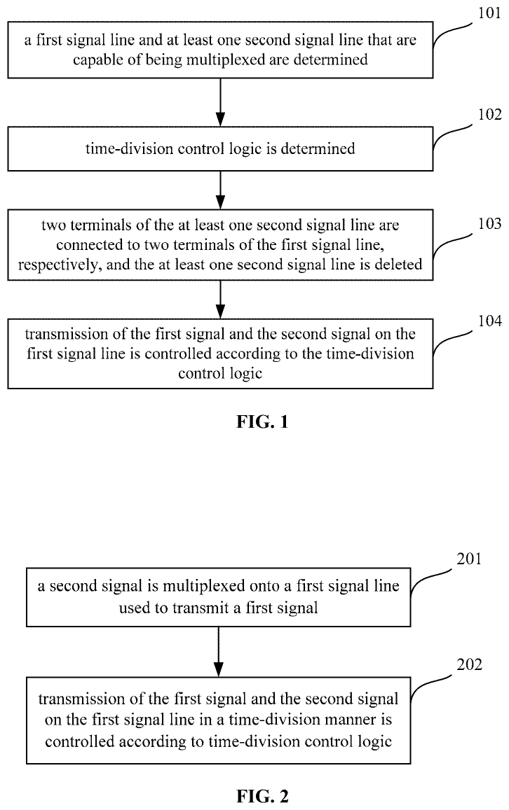

FIG. 1 is a flow chart of a method for reducing routings between modules according to an embodiment of the present disclosure. The method includes steps 101 to 104.

In 101, a first signal line and at least one second signal line that are capable of being multiplexed are determined.

The first signal line is used to transmit a first signal, and the second signal line is used to transmit a second signal.

In some embodiments, the first signal line may be but not limited to any one of the following: a signal line for transmitting a control waveform, or a signal line for transmitting an operating parameter. Similarly, the at least one second signal line may also be but not limited to any one or more of the following: the signal line for transmitting the control waveform, or the signal line for transmitting the operating parameter.

In some embodiments, as needed, two or more signal lines for transmitting the same type or different types of signals may be multiplexed. For example, a signal line for transmitting a control waveform may be multiplexed with two signal lines for transmitting different operating parameters; or two signal lines for transmitting different control waveforms may be multiplexed; or three signal lines for transmitting different operating parameters may be multiplexed.

In 102, time-division control logic is determined.

The time-division control logic refers to time-division control logic for different signals multiplexed onto the same signal line.

In 103, two terminals of the at least one second signal line are connected to two terminals of the first signal line, respectively, and the at least one second signal line is deleted.

It should be noted that connecting the two terminals of the two signal lines is equivalent to merging the two signal lines into one signal line. Accordingly, when routing, the routing of any one of the signal lines can be deleted. That is, the first signal line and the second signal line are not limited to a specific signal, but are only used to distinguish different signal lines. Further, if there are more than two multiplexed signal lines, after connecting their terminals, only the routing of one of the signal lines may be retained, while the routings of other signal lines may be deleted.

In 104, transmission of the first signal and the second signal on the first signal line is controlled according to the time-division control logic.

For example, if the first signal and the second signal are multiplexed onto the first signal line or the second signal line for transmission, the time-division control logic needs to guarantee that the first signal and the second signal can be transmitted to required signal receiving terminals in a time-division manner, and the transmission of the two signals does not affect each other. Similarly, if more than two different signals need to be multiplexed for transmission, it is also necessary to guarantee that these signals do not affect each other. Therefore, the first signal line may be controlled by a time-division selection signal and a latch signal to transmit all multiplexed signals in the time-division manner, such as the first signal and the second signal.

Considering an example of multiplexing a real-time varying control waveform signal line in a time-division manner, that is, when an operating parameter signal is multiplexed onto the signal line for transmitting the control waveform, it is possible to choose to, within a certain time period, output an operating parameter signal and latch the operating parameter signal through a memory according to the latch signal for a need of corresponding modules, while at other times, still transmit the waveform signal. In addition, one signal line can transmit one or more operating parameters in the time-division manner, which only requires providing multiple memories and cooperating with corresponding latch signals.

It should be noted that the time-division selection signal generally needs to be provided independently, and in addition, the latch signal may be provided independently, that is, being transmitted separately, or may be transmitted in time-division multiplexing with other signals, which is not limited in the embodiments of the present disclosure.

In some embodiments, the time-division selection signal and the latch signal may control multiple channels of time-division multiplexing transmission operating parameters. When there are many multiplexed transmission signals and many latch signals, the number of latch signals may be reduced by a manner of encoding (such as address encoding).

In the method for reducing routings between modules provided in the embodiments of the present disclosure, signals that need to be transmitted by different signal lines are multiplexed onto one signal line in a time-division multiplexing manner, thereby effectively reducing a number of signal lines. In particular, for a layout design with few metal layers and long distances between modules and between routings, a chip size may be effectively reduced, and miniaturization of a device may be improved.

Accordingly, an embodiment of the present disclosure further provides a signal transmission method, as shown in FIG. 2 which is a flow chart of the signal transmission method including steps 201 and 202.

In 201, a second signal is multiplexed onto a first signal line used to transmit a first signal.

It should be noted that types of the first signal and the second signal may be the same or different, and may be but is not limited to any one of the following: a waveform signal that varies in real time to provide a control function, or a signal for transmitting stable circuit operating parameters.

In 202, transmission of the first signal and the second signal on the first signal line in a time-division manner is controlled according to time-division control logic.

The time-division control logic is used to control time-division transmission of the first signal and the second signal on the first signal line, without affecting each other. Specifically, the transmission of the first signal and the second signal on the first signal line in the time-division manner may be controlled based on the time-division selection signal and the latch signal.

Further, in a case where a plurality of latch signals are required, the plurality of latch signals may be generated by a manner of encoding.

It should be noted that in practice, more than two different signals may be multiplexed onto one signal line for transmission, which may effectively improve the transmission capability of the signal lines, minimize the routings between different modules, reduce the number of signal lines, and thereby reduce a chip size and improve miniaturization of a device.

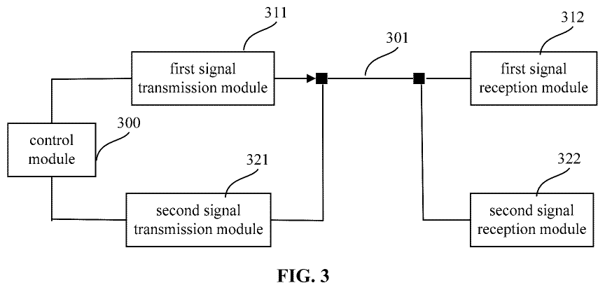

Accordingly, an embodiment of the present disclosure further provides a signal transmission apparatus. Referring to FIG. 3, FIG. 3 is a structural block diagram of the signal transmission apparatus.

The signal transmission apparatus includes: a first signal transmission module 311, a second signal transmission module 321, a first signal reception module 312, a second signal reception module 322, and a control module 300. The first signal transmission module 311 is connected with the first signal reception module 312 via a signal line 301, and the second signal transmission module 321 is connected with the second signal reception module 322 via the signal line 301 as well.

The first signal transmission module 311 is configured to output a first signal, and accordingly, the first signal reception module 312 is configured to receive the first signal. Similarly, the second signal transmission module 321 is configured to output a second signal, and accordingly, the second signal reception module 322 is configured to receive the second signal.

In the embodiments, the first signal and the second signal are both transmitted via the signal line 301, and the control module 300 controls the signal line 301, according to time-division control logic, to transmit the first signal to the first signal reception module 312 and the second signal to the second signal reception module 322 in a time-division manner.

It should be noted that the second signal may be a signal of the same type as the first signal, or a signal of a different type, which is not limited in the embodiments of the present disclosure.

To enable the first signal and the second signal to be transmitted on the signal line in the time-division manner without interfering with each other, in some embodiments, the signal transmission apparatus may further include a port selection module (not shown).

Accordingly, in the embodiments, the control module 300 is configured to output a time-division selection signal to the first signal transmission module 311 and the second signal transmission module 321 respectively, and output a control signal to the port selection module to control the port selection module to be connected to the first signal reception module 312 and the second signal reception module 322 in the time-division manner.

When there is an operating parameter signal in the multiplexed signals, for example, the second signal is an operating parameter signal, accordingly, the port selection module may latch the second signal through a memory connected with the second signal reception module 322. When the port selection module is connected to the second signal reception module 322, the operating parameters latched in the memory are transmitted to the second signal reception module 322.

It should be noted that, in specific applications, a plurality of operating parameter signals may be multiplexed and transmitted simultaneously on one signal line. In this case, a plurality of memories are required, that is, each operating parameter requires a corresponding memory for latching. To avoid too many latch signals, the control signal may be encoded by a corresponding encoding module (not shown), such as address encoding, to output a latch signal for controlling operation of each memory.

It should be noted that the memory may be a latch, a D flip-flop, or other circuit units with a storage function, which is not limited in the embodiments of the present disclosure.

The signal transmission method and apparatus provided in the embodiments of the present disclosure multiplex different signals onto the same signal line, and control transmission of the different signals on the signal line in the time-division manner according to the time-division control logic, which may effectively improve transmission capability of the signal line and reduce a number of signal lines.

Accordingly, an embodiment of the present disclosure further provides an image sensor, including the above signal transmission apparatus.

Accordingly, an embodiment of the present disclosure further provides a chip, including the above signal transmission apparatus.

Each module/unit of each apparatus and product described in the above embodiments may be a software module/unit or a hardware module/unit, or may be a software module/unit in part, and a hardware module/unit in part. For example, for each apparatus or product applied to or integrated in a chip, each module/unit included therein may be implemented by hardware such as circuits; or, at least some modules/units may be implemented by a software program running on a processor integrated inside the chip, and the remaining (if any) part of the modules/units may be implemented by hardware such as circuits. For each apparatus or product applied to or integrated in a chip module, each module/unit included therein may be implemented by hardware such as circuits. Different modules/units may be disposed in a same component (such as a chip or a circuit module) or in different components of the chip module. Or at least some modules/units may be implemented by a software program running on a processor integrated inside the chip module, and the remaining (if any) part of the modules/units may be implemented by hardware such as circuits. For each apparatus or product applied to or integrated in a terminal, each module/unit included therein may be implemented by hardware such as circuits. Different modules/units may be disposed in a same component (such as a chip or a circuit module) or in different components of the terminal. Or at least some modules/units may be implemented by a software program running on a processor integrated inside the terminal, and the remaining (if any) part of the modules/units may be implemented by hardware such as circuits.

In an embodiment of the present disclosure, a computer readable storage medium having computer instructions stored therein is provided, where when the computer instructions are executed, the above method as shown in FIG. 1 or FIG. 2 is performed. In some embodiments, the storage medium may include a ROM, a RAM, a magnetic disk or an optical disk. In some embodiments, the storage medium may include a non-volatile or a non-transitory memory.

It should be understood that the term “and/or” in the present disclosure is merely an association relationship describing associated objects, indicating that there can be three types of relationships, for example, A and/or B can represent three situations including “A exists only”, “both A and B exist”, and “B exists only”. In addition, the character “/” in the present disclosure represents that the former and latter associated objects have an “or” relationship.

The “plurality” in the embodiments of the present disclosure refers to two or more.

The descriptions of the first, second, etc. in the embodiments of the present disclosure are merely for illustrating and differentiating the objects, and do not represent the order or the particular limitation of the number of devices in the embodiments of the present disclosure, which do not constitute any limitation to the embodiments of the present disclosure.

It should be understood that, in the various embodiments of the present disclosure, sequence numbers of the above-mentioned processes do not represent an execution sequence, and the execution sequence of each process should be determined by its function and inherent logic, which does not limit an implementation process of the embodiments of the present disclosure.

In the above embodiments of the present disclosure, it should be understood that the disclosed method, apparatus and system may be implemented in other ways. For example, the above device embodiments are merely illustrative, and for example, division of units is merely one logical division, and other divisions may be realized in practice, for example, a plurality of units or components may be combined or integrated into another system, or some features may be omitted, or not executed. Further, the shown or discussed mutual coupling or direct coupling or communication connection may be an indirect coupling or communication connection via some interfaces, devices or units, and may be in an electrical, mechanical or other form.

The units described as separate parts may or may not be physically separate, and parts shown as units may or may not be physical units, that is, may be disposed in one place, or may be distributed on a plurality of network units. Some or all of the units can be selected according to practical requirements to achieve the purpose of the solutions of the embodiments.

In addition, functional units in the embodiments of the present disclosure may be integrated in one processing unit, or each unit may be physically separate, or two or more units may be integrated in one unit. The integrated units can be realized in a form of hardware, or in a form of hardware plus a software functional unit.

The integrated units implemented in the form of the software functional unit may be stored in a computer readable storage medium. The software functional unit is stored in a storage medium and includes several instructions for causing a computer device (a personal computer, a server or a network device) to execute some steps of the methods in the embodiments of the present disclosure.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

1. A method for reducing routings between modules, comprising:
determining a first signal line and at least one second signal line that are capable of being multiplexed, wherein the first signal line is used to transmit a first signal, and the second signal line is used to transmit a second signal;
determining time-division control logic;
connecting two terminals of the at least one second signal line to two terminals of the first signal line, respectively, and deleting the at least one second signal line; and
controlling to transmit the first signal and the second signal on the first signal line according to the time-division control logic.

2. The method according to claim 1, wherein the first signal line is any one of the following: a signal line for transmitting a control waveform, or a signal line for transmitting an operating parameter.

3. The method according to claim 2, wherein the at least one second signal line comprises one or more second signal lines; and
the at least one second signal line comprises any one or more of the following: the signal line for transmitting the control waveform, or the signal line for transmitting the operating parameter.

4. The method according to claim 1, wherein the time-division control logic comprises:
controlling to transmit the first signal and the second signal on the first signal line in a time-division manner based on a time-division selection signal and a latch signal.

5. The method according to claim 4, further comprising:
in a case where a plurality of latch signals are required, reducing a number of the plurality of latch signals by a manner of encoding.

6. A signal transmission method, comprising:
multiplexing a second signal onto a first signal line used to transmit a first signal; and
controlling to transmit the first signal and the second signal on the first signal line in a time-division manner according to time-division control logic.

7. The method according to claim 6, wherein the first signal and the second signal comprise any one or more of the following: an operating parameter signal and a control waveform signal.

8. The method according to claim 6-er 7, wherein said controlling to transmit the first signal and the second signal on the first signal line in the time-division manner according to the time-division control logic comprises:
controlling to transmit the first signal and the second signal on the first signal line in the time-division manner based on a time-division selection signal and a latch signal.

9. The method according to claim 8, further comprising:
in a case where a plurality of latch signals are required, generating the plurality of latch signals by a manner of encoding.

10. A signal transmission apparatus, comprising: a first signal transmission module, a first signal reception module connected to the first signal transmission module via a signal line, at least one second signal transmission module, at least one second signal reception module connected to the at least one second signal transmission module via the signal line, and a control module;
wherein the first signal transmission module is configured to output a first signal;
the at least one second signal transmission module is configured to output a second signal; and
the control module is configured to control to transmit the first signal to the first signal reception module and transmit the second signal to the at least one second signal reception module on the signal line in a time-division manner according to time-division control logic.

11. The apparatus according to claim 10, wherein the first signal and the second signal comprise any one or more of the following: an operating parameter signal and a control waveform signal.

12. The apparatus according to claim 10, wherein the second signal and the first signal are signals of a same type or signals of different types.

13. The apparatus according to claim 10, further comprising a port selection module;
wherein the control module is configured to output a time-division selection signal to the first signal transmission module and the at least one second signal transmission module respectively, and output a control signal to the port selection module to control the port selection module to be connected to the first signal reception module and the at least one second signal reception module in a time-division manner.

14. The apparatus according to claim 13, wherein the second signal is an operating parameter signal, and the port selection module comprises at least one memory connected to the at least one second signal reception module and used to store the second signal.

15. The apparatus according to claim 14, wherein the at least one second signal transmission module and the at least one second signal reception module comprise a plurality of second signal transmission modules and a plurality of second signal reception modules; and
the apparatus further comprises an encoding module configured to encode the control signal and output a latch signal for controlling operation of each of the at least one memory.

16. An image sensor, comprising the signal transmission apparatus according to claim 10.

17. The method according to claim 7, wherein said controlling to transmit the first signal and the second signal on the first signal line in the time-division manner according to the time-division control logic comprises:
controlling to transmit the first signal and the second signal on the first signal line in the time-division manner based on a time-division selection signal and a latch signal.

18. The method according to claim 17, further comprising:
in a case where a plurality of latch signals are required, generating the plurality of latch signals by a manner of encoding.

19. The apparatus according to claim 11, further comprising a port selection module;
wherein the control module is configured to output a time-division selection signal to the first signal transmission module and the at least one second signal transmission module respectively, and output a control signal to the port selection module to control the port selection module to be connected to the first signal reception module and the at least one second signal reception module in a time-division manner.

20. The apparatus according to claim 12, further comprising a port selection module;
wherein the control module is configured to output a time-division selection signal to the first signal transmission module and the at least one second signal transmission module respectively, and output a control signal to the port selection module to control the port selection module to be connected to the first signal reception module and the at least one second signal reception module in a time-division manner.
